(19) United States
(12) Patent Application Publication
(10) Pub. No.: US 2026/0217063 A1
(43) Pub. Date: Jul. 30, 2026

(54) TIRE WITH RECYLED RUBBER IN BEAD

(71) Applicants: Tyler SITES, Greenville, SC (US); Candy TSIAO, Greenville, SC (US); COMPAGNIE GENERALE DES ETABLISSEMENTS MICHELIN, Clermont-Ferrand (FR)

(72) Inventors: Tyler SITES, Greenville, SC (US); Candy TSIAO, Simpsonville, SC (US)

(21) Appl. No.: 19/145,072

(22) PCT Filed: Jan. 12, 2024
(86) PCT No.: PCT/US2024/011309

§ 371 Date: Jul. 1, 2025

Related U.S. Application Data
(60) Provisional application No. 63/479,576, filed on Jan. 12, 2023.

(51) Int. Cl. B60C 15/06

(52) U.S. Cl. CPC B60C 15/0607; B60C 15/0632; B60C 2015/065; B60C 2200/06

(57) ABSTRACT

A tire is provided that has a bead that has a reinforcement ply with a main portion (32) and a return casing ply (34) that extends from the main portion. The bead also includes a stiffener layer (38). A virgin bead filler (86, 84) is present that includes virgin rubber, and recycled bead filler (80, 82, 92) is included that is made of recycled rubber. The outward radial terminal end (76) of the return casing ply is closer to the virgin bead filler than to the recycled bead filler, and the outward radial terminal end of the return casing ply is not in engagement with the recycled bead filler. The outward radial terminal end of the stiffener layer is closer to the virgin bead filler than to the recycled bead filler, and the outward radial terminal end of the stiffener layer is not in engagement with the recycled bead filler.

### STATEMENT REGARDING FEDERALLY SPONSORED RESEARCH OR DEVELOPMENT

This invention was made with government support under the Advanced Manufacturing Office Award Number DE-EE0007897 awarded by the U.S. Department of Energy's Office of Energy Efficiency and Renewable Energy (EERE). The Government has certain rights in the invention.

### FIELD OF THE INVENTION

The subject matter of the present invention relates to a tire that includes recycled rubber. More particularly, the present application involves a bead design that features both virgin bead filler and recycled bead filler strategically placed to maintain tire performance.

### BACKGROUND OF THE INVENTION

Once tires have gone through their useful life, they are removed from service and enter their after service life. Around 50% of tires upon entering their after service life are burned to create tire-derived fuel. Of the remaining after service life tires, some are repurposed into crumb rubber products, others are used for civil engineering applications, and the remaining after service life tires are ground and placed into landfills. In order to reduce the environmental impact of after service life tires, it may be desirable to repurpose rubber from after service tires into new tires that are being manufactured. However, only smaller amounts of recycled rubber are used in new tires because adding larger amounts of recycled rubber into new tires has been shown to lower functional properties such as strain modulus and tensile strength. It is therefore the case that using recycled rubber instead of new, virgin rubber in newly manufactured tires can degrade the tire's performance. This downside thus limits the applicability of recycled rubber into newly manufactured tires. It would therefore be desirable to design a tire that allows for the incorporation of recycled rubber into a newly manufactured tire without degrading the performance of the newly manufactured tire due to the incorporation of this recycled rubber.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a perspective view of a heavy truck tire.

FIG. 2 is a cross-sectional view of a radial cut of a truck tire with all items in cross-section as the tire would look when mounted to a rim.

FIG. 3 is a cross-sectional view of a bead as it would look when mounted to a rim in accordance with one exemplary embodiment.

FIG. 4 is a cross-sectional view of a bead in accordance with another exemplary embodiment.

FIG. 5 is a cross-sectional view of a bead in accordance with yet another exemplary embodiment.

The use of identical or similar reference numerals in different figures denotes identical or similar features.

### DETAILED DESCRIPTION OF THE INVENTION

Reference will now be made in detail to embodiments of the invention, one or more examples of which are illustrated in the drawings. Each example is provided by way of explanation of the invention, and not meant as a limitation of the invention. For example, features illustrated or described as part of one embodiment can be used with another embodiment to yield still a third embodiment. It is intended that the present invention include these and other modifications and variations.

The present invention provides for a tire 10 with recycled rubber incorporated into the bead 24 in such a manner that endurance and durability is not compromised. In this regard, the recycled bead filler 78 is not in engagement with an outward radial terminal end 76 of a return casing ply 34 of a reinforcement ply 32, and is not in engagement with an outward radial terminal end 58 of a stiffener layer 38. These terminal ends 76 and 58 are located closer to virgin bead filler 36 than to the recycled bead filler 78. These arrangements allow for recycled rubber to be put into a newly manufactured tire without degrading the performance of the tire. In some embodiments, a multi-layer strategy is used to construct the virgin and recycled bead fillers 36 and 78 to further ensure product performance with the incorporated amount of recycled material.

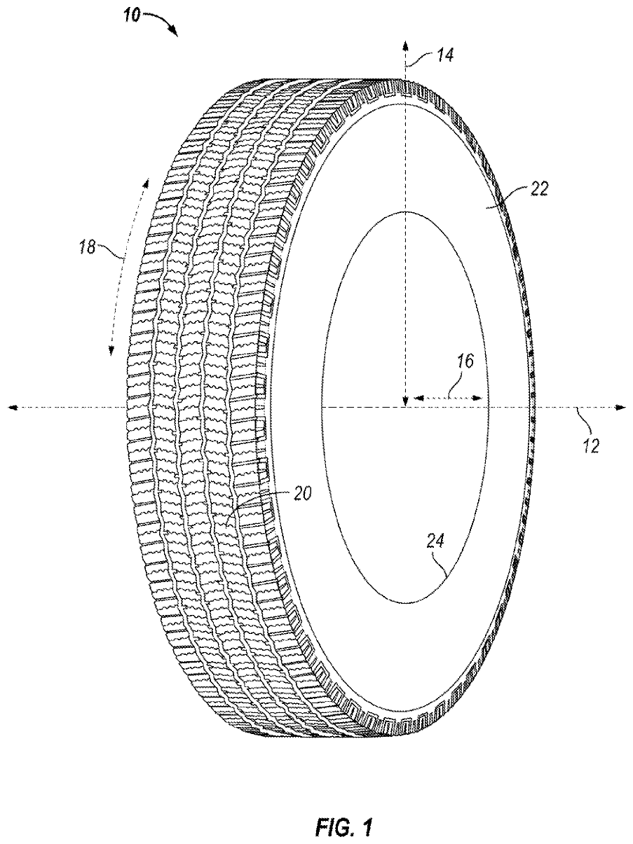

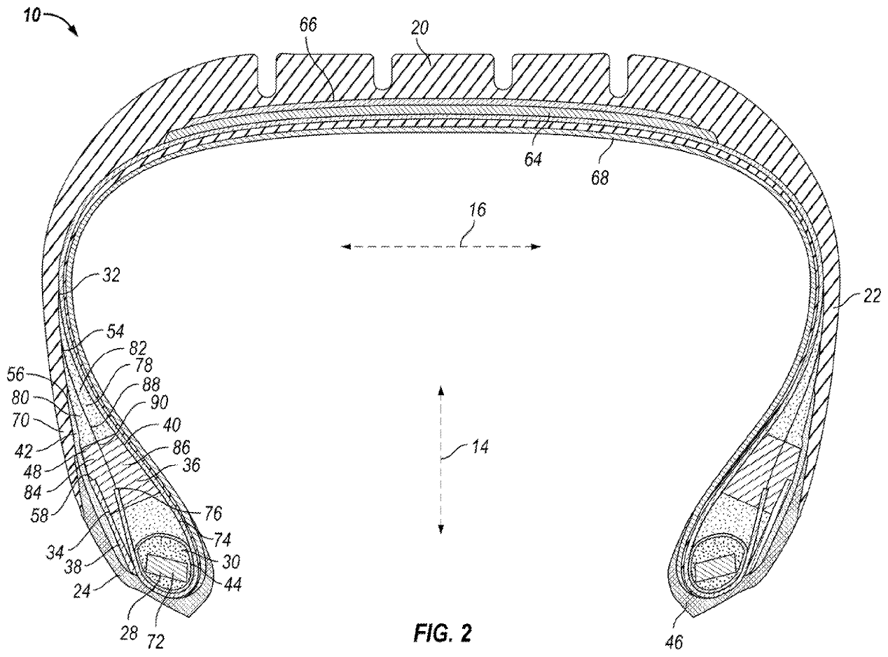

FIG. 1 shows a tire 10 that is a heavy duty truck tire 10. The tire 10 may be a steer tire, a drive tire, a trailer tire, or an all position tire. The tire 10 includes a casing 22 onto which a tread 20 is disposed thereon. The bead 24 is a part of the casing 22 that is at the inner radial end of the casing 22 closest to the central axis 12. The central axis 12 of the tire 10 extends through the center of the casing 22, and the axial direction 16 of the tire 10 is parallel to the central axis 12. The radial direction 14 of the tire 10 is perpendicular to the central axis 12, and the tread 20 is located farther from the central axis 12 in the radial direction 14 than the casing 22. The tread 20 extends all the way around the casing 22 in the circumferential direction 18 of the tire 10 and circles the central axis 12 360 degrees. Although described as being in use with heavy duty truck tires 10, the tire 10 as provided in accordance with the present invention may be any type of tire 10 such as a light duty vehicle tire, a light truck tire, a passenger car tire, or any other type of tire 10. However, certain embodiments exist in which the tire 10 is a heavy duty truck tire 10. As used herein, the directions described as being outward or inward in the radial direction 14 mean farther or closer to something relative to the central axis 12 in the radial direction 14. The directions described as being inboard or outboard in the axial direction 16 mean closer to or farther from the center line of the tire 10 in the axial direction 16 that is designated as the radial direction 14 line in FIG. 2.

FIG. 2 is a radial cut of a tire 10 in accordance with one exemplary embodiment. Various tissues, sometimes called products, composed of different materials can be present throughout the tire 10. The tread 20 of the tire 10 is shown as being located farthest from the axial center of the tire 10 in the radial direction 14. A first belt layer 64 and a second belt layer 66 are located below the tread 20 in the radial direction 14 and comprise belts for use in strengthening and holding the form of the tire 10. The reinforcement belts of the layers 64, 66 may be crossed relative to one another, and in some instances they can be arranged at an angle of 20 degrees to one another. The casing 22, or carcass, extends from the tread 20 and includes sidewalls of the tire 10 terminating in a pair of beads 24 that are arranged for mounting onto the rim of the wheel of the vehicle. A bead core 28 is located in each one of the beads 24 and is present to provide strength and a gripping force in the bead 24 for retention onto the rim. The left hand side bead 24 can be a mirror image of the right hand side bead 24 and both beads 24 can have products that are made of the same material. Some of the tissues/products are located only in the bead 24, while others are located in the bead 24 and extend therefrom. For instance, an inner liner 68 is inside of the bead 24 and extends to an inner, exterior side of the bead 24 before extending up the sidewall of the casing 22. The inner liner 68 then extends across the entire inner side of the crown in the axial direction 16 before extending into and forming the inner side of the right hand side wall of the casing 22. The inner liner 68 then terminates inside of the right hand side bead 24 and is arranged in a similar mirror-image manner to its presence in the left hand side bead 24. The inner liner 68 is thus a product of the tire 10 that extends all the way from one bead 24 to the other bead 24 and is made of a material that is fluid tight so that fluid between the tire 10 and rim is maintained therein for purposes of maintaining inflation pressure of the tire 10.

The tire 10 includes a tissue designated as a reinforcement ply 32 that is located within one of the beads 28 and extends through the casing 12 and crown to the other bead 28. The reinforcement ply 32 wraps around the bead core 28 and is designated as a return casing ply 34 in the location outward in the axial direction 16 from the bead core 28. The reinforcement ply 32 has a main portion 74 that is in the bead 24 and is inboard from the return casing ply 34 in the axial direction 16. The main portion 74 extends to the bead core 28 to a location of the reinforcement ply 32 that is closest to the central axis 12 in the radial direction 14. At the this location closest to the central axis 12 in the radial direction 14, the reinforcement ply 32 is then designated as a return casing ply 34 which extends from this point to an outward radial terminal end 76 of the return casing ply 34 which is the part of the return casing ply 34 farthest from the central axis 12 in the radial direction 14. It is thus the case that both the main portion 74 and the return casing ply 34 are wrapped around the bead core 28 and both may engage the bead core 28 in some embodiments. In the bead 24, the return casing play 34 may be completely located outboard of the main portion 74 in the axial direction 16, although this arrangement need not always be the case. The main portion 74 and return casing ply 34 can be continuous with one another with no interruption in the reinforcement ply 32 from one to the other.

Relative positions in the axial direction 16 can be described with respect to inboard and outboard positions. The most inboard point of the tire 10 may be the radial direction line 14 shown in FIG. 2 in its location in FIG. 2 as it is located at the center of the tire 10 in the axial direction 16. The center of the tire 10 is inboard of both of the beads 24 in the axial direction 16. It is therefore the case as used herein, an object described as inboard in the axial direction 16 to another object means that it is located closer to the radial direction line 14 as shown in FIG. 2 or as would be located in the other figures. Further, as used herein an object described as being located outboard from another object in the axial direction 16 means that it is located farther from the radial direction line 14 in the axial direction 16 as shown in FIG. 2 or as would be located in the other figures. As another example, the bead layer 42 is outboard of the bead core 28 in the axial direction 16. Relative positioning in the radial direction 14 may be described in relation to the central axis 12 in which objects may be closer to or farther from the central axis 12 in the radial direction 14 than other objects. Although the central axis 12 is not shown in every figure due to sizing constraints, it is to be understood that when describing something as closer or farther in the radial direction 14, the position of the central axis 12 as would be seen should be referenced in order determine the relative positioning.

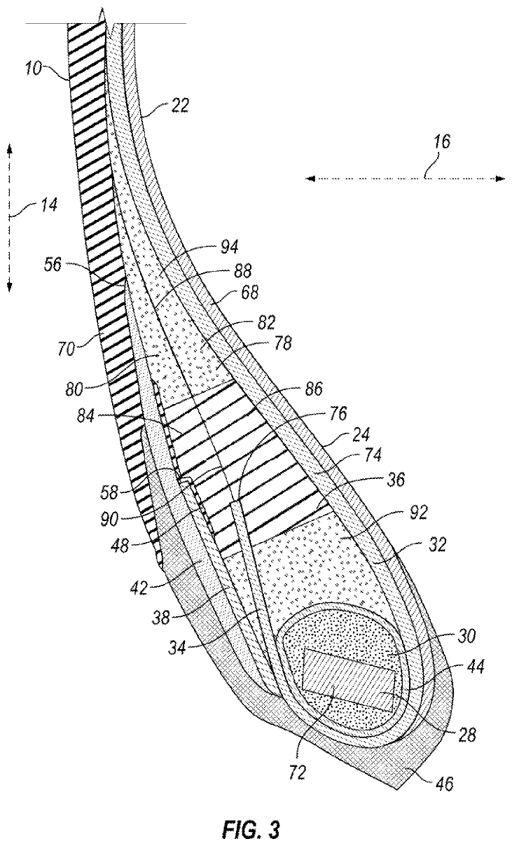

FIG. 3 is a close up view of the left hand side bead 24 in accordance with another exemplary embodiment. The bead core 28 is made up of one or more steel rods 72. The bead core 28 is surrounded by the padding gum 30 and in some instances may be completely surrounded on all sides by the padding gum 30. Surrounding the bead core 28 is a wrapping tissue 44 that can be made of nylon in some embodiments. The rod 72 making up the bead core 28 is shown as a single piece and has a rectangular cross-sectional shape. This single piece can actually be many rods arranged together in the shape of a rectangle. In other embodiments the bead core 28 can be made of multiple components and these components could have any cross-sectional shape. The wrapping tissue 44 wraps around the padding gum 30 to isolate the rod 72 and padding gum 30 from other elements of the tire 10 such as the reinforcement ply 32 and fillers. The wrapping tissue 44 may have a stiffness of 14 MPa and can be made of a rubber mix and textile which in some instances can be a nylon ply, the padding gum 30 can be a rubber mix and may have a stiffness of 28 MPa, and the rod 72 can be made of steel or aluminum and can have a stiffness of 30,000,000 MPa in some embodiments. The bead core 28 can be lightened so that a smaller rod can be used to improve performance properties of the tire 10.

The bead 24 includes both virgin bead filler 36 and recycled bead filler 78, both sometimes referred to as gum stuffing, that are both between and engage both the reinforcement ply 32, main portion 74, and the return casing ply 34. The wrapping tissue 44 engages the recycled bead filler 78, the main portion 74, the return casing ply 34, and the wrapping tissue 44. The virgin bead filler 36 does not engage the wrapping tissue 44. The wrapping tissue 44 functions to stabilize the geometry of the padding gum 30 and the rod 72. If the wrapping tissue 44 were not present, the padding gum 30 would assume a more square shape upon formation, and would assume a more oval shape when the tire 10 is used. The wrapping tissue 44 thus causes the tissues of the bead 24 to be desirably shaped so that they can function in an intended manner. It is to be understood that other truck tires 10 can be made without a wrapping tissue 44 and can function in a completely normal and safe manner. The addition of a wrapping tissue 44 may provide an even higher bead 24 endurance performance than in those instances in which a wrapping tissue 44 is absent in the bead 24. However, various truck tire 10 designs in accordance with the present design exist that are fully functional and safe that both include and do not include a wrapping tissue 44.

The recycled bead filler 78 is also located between and engages both the stiffener layer 38 and the return casing ply 34. The virgin bead filler 36 is not in engagement with the bead core 28. The virgin bead filler 36 is located between the main portion 74 and the stiffener layer 38 and engages both of these elements. The virgin bead filler 36 also engages the return casing ply 34, tape 48, and the recycled bead filler 78. The return casing ply 34 has an outward radial terminal end 76 that is the portion of the return casing ply 34 that is most outward in the radial direction 14 from the central axis 12, and is the farthest part of the return casing ply 34 from the central axis 12 in the radial direction 14. The outward radial terminal end 76 engages the virgin bead filler 36, and this is the only element of the tire 10 that the outward radial terminal end 76 engages. The outward radial terminal end 76 is closer to the virgin bead filler 36 than it is to the recycled bead filler 78. The recycled bead filler 78 does not engage the outward radial terminal end 76. The return casing ply 34 extends into the virgin bead filler 36 and terminates within the virgin bead filler 36. The stiffener layer 38 has an outward radial terminal end 58 that is the portion of the stiffener layer 38 that is farthest from the central axis 12 in the radial direction 14. The outward radial terminal end 58 is closer to the virgin bead filler 36 than to the recycled bead filler 78, and the outward radial terminal end 58 is not in engagement with the recycled bead filler 78. Tape 48 surrounds the outward radial terminal end 58 so that it does not engage the virgin bead filler 36, but it could be said that the stiffener layer 38 extends outward in the radial direction 14 and terminates in the virgin bead filler 36. The stiffener layer 38 engages the bead layer 42, virgin bead filler 36, recycled bead filler 78, and the return casing ply 34.

The virgin bead filler 36 is located within the bead 24 and is positioned so as to cause the recycled bead filler 78 to be separated into a first zone 92 and a more radially outward located second zone 94. The recycled bead filler 78 is thus discontinuous in the radial direction 14 so that it is not continuous along its entire length in the radial direction 14. The first zone 92 engages the wrapping tissue 44, reinforcement ply 32 including the return casing ply 34, the virgin bead filler 36, and the stiffener layer 38. The second zone 94 engages the virgin bead filler 36, the main portion 74 of the reinforcement ply 32, the tape 48, the bead layer 42, and the sidewall product 70. The volume of material in the first zone 92 may be different than the volume of material in the second zone 94.

The recycled bead filler 78 and virgin bead filler 36 can be placed into the bead 24 as single, individual components during tire 10 constructions. Alternatively, these tissues 78, 36 may be formed in one or more layers in the tire 10 building process. In FIG. 3, both the recycled bead filler 78 and the virgin bead filler 36 are made of two layers. The recycled bead filler 78 is made of a recycled bead filler first layer 80 and a recycled bead filler second layer 82 and both of these layers 80, 82 are located in the first and second zones 92, 94. The recycled bead filler first layer 80 engages the bead layer 42, tape 48, sidewall product 70, and the virgin bead filler 36 in the second zone. The recycled bead filler second layer 82 engages the stiffener layer 38, return casing ply 34, and the virgin bead filler 36 in the first zone 92. The recycled bead filler second layer 82 in the second zone 94 engages the sidewall product 70, main portion 74, and the virgin bead filler 36. The recycled bead filler second layer 82 in the first zone 92 engages the wrapping tissue 44, main portion 74, and the return casing ply 34.

In the second zone 94, the recycled bead filler first layer 80 and the recycled bead filler second layer 82 engage one another with an interface 88 defined at the point of their engagement. The interface 88 engages the sidewall product 70 and extends from it to an interface 90 of the virgin bead filler 36. The first zone 92 does not have an interface 88 because the recycled bead filler first layer 80 is separated from, and not in engagement with, the recycled bead filler second layer 82 because of the presence of the return casing ply 34. As such, in the first zone 92, the recycled bead filler first layer 80 does not engage the recycled bead filler second layer 82. The volume of recycled bead filler in the recycled bead filler first layer 80 may be the same as or different from the volume of material present in the recycled bead filler second layer 82. The material making up the recycled bead filler first layer 80 may be the exact same material as that which makes up the recycled bead filler second layer 82. The layers 80, 82 can be laid down onto the other tissues as separate layers in the tire 10 building process.

The virgin bead filler 36 is made up of a virgin bead filler first layer 84 and a virgin bead filler second layer 86 with an interface 90 at the engagement between the two layers 84, 86. The interface 90 engages the interface 88 and extends from the interface 88 to and in engagement with the outward radial terminal end 76. The first layer 84 engages the tape 48, stiffener layer 38, the return casing ply 34 including the outward radial terminal end 76, and the recycled bead filler first layer 80. The virgin bead filler second layer 86 engages the main portion 74, return casing ply 34 including the outward radial terminal end 76, and the recycled bead filler second layer 82. The two layers 84, 86 may be made of the exact same material, and may the same volume or a different volume from one another. The layers 84, 86 can be applied at different times in the tire 10 building process and need not be immediately sequentially applied. The presence of the return ply casing 34 separates a portion of the virgin bead filler first layer 84 from the virgin bead filler second layer 86. The virgin bead filler 36 engages both and separates the first zone 92 from the second zone 94, and the first zone 92 is not in engagement with the second zone 94.

The virgin bead filler 36 and the recycled bead filler 78 are rubber mixes that are different than the rubber mix making up the padding gum 30. The materials making up the virgin bead filler 36 and recycled bead filler 78 can be more flexible than the material making up the padding gum 30. The bead fillers 36, 78 can have stiffnesses in the range from 3.6 MPa to 5.6 MPa. The bead fillers 36, 78 end in the bead 24 or in some instances may extend into the sidewall of the tire 10. However, the bead fillers 36, 78 do not extend all the way under the belt layers 64, 66 to the other sidewall of the tire 10. The reinforcement ply 32 is a composite material that includes metal cords and a rubber mix. The reinforcement ply 32 in the direction of its cords is stiffer than the wrapping tissue 44, the bead fillers 36, 78 and the padding gum 30. The reinforcement ply 32 extends from the bead 24, through the sidewall, under the belt layers 64, 66, and then into the opposite sidewall and down into the bead 24 on the right hand side of the tire 10.

The stiffener layer 38 is located outboard from the return casing ply 34 in the axial direction 16 and contacts the return casing ply 34 along a portion of its length. The stiffener layer 38 terminates in the bead 24 so that some of it is located inward in the radial direction 14 from parts of the bead core 28. Other portions of the stiffener layer 38 are outward in the radial direction 14 from the bead core 28. The stiffener layer 38 can be made of a combination of steel and rubber, and this rubber may have a stiffness of 10 MPa. The bead 24 includes an anti-abrasive strip 46 that is on the outside of the bead 24 and is designed to engage the rim. The anti-abrasive strip 46 engages the stiffener layer 38, but need not in other arrangements. The stiffener layer 38 in FIG. 3 extends outward in the radial direction 14 to have a portion outward of the bead core 28, and the return casing ply 34 in the radial direction 14.

The bead layer 42 is a product of the tire 10 made of rubber that has a portion that engages the stiffener layer 38 and is located between the stiffener layer 38 and the anti-abrasive strip 46. The bead layer 42 extends outward in the radial direction 14 to an outward radial terminal end 56 that is the farthest outward position of the bead layer 42 from the central axis 12 in the radial direction 14 and engages the tape 48, the recycled bead filler first layer 80, and the sidewall product 70. The outward radial terminal end 56 is positioned slightly inward of a portion of the recycled bead filler 78 in the radial direction 14. The bead layer 42 may terminate in the bead 24, and may or may not extend to the sidewall of the tire 10. However, the bead layer 42 does not extend to be under the belt layers 64, 66, and does not extend to the right hand side sidewall or right hand side bead 24. A sidewall product 70 is in the sidewall and may have a stiffness that is 3.6 to 5.6 MPa. The bead layer 42 is free from engagement with the return casing ply 34 and the bead core 28 and is an interior product of the tire 10 and does not have any portion that forms the outer surface of the tire 10.

The present application describes the stiffness of a product or material. The stiffness that is being referred to is the Young's modulus which is the stiffness of an elastic material, or elastic modulus. The stiffness is provided in measurements of mega pascals (MPa). The stiffness material property in question that is being referred to is MA10. This stiffness property can be calculated using French standard NF T 46-002, September 1988.

Tape 48 is located in the bead 24 and engages the stiffener layer 38, the bead layer 42, and both the virgin and recycled bead filler 36 and 78. The tape 48 may be present on the end of the stiffener layer 38 when the stiffener layer 38 is assembled into the green tire 10 before curing. The tape 48 could be wrapped around the outward radial terminal end 58 in this regard before and after assembly of the stiffener layer 38 into the tire 10. Although the tape 48 is shown as being present, it is to be understood that the tape 48 is not present in the tire 10 in other exemplary embodiments of the tire 10. The provided configuration of the bead 24 allows the elimination of tape 48 at the ends of all products thus decreasing cost of the tire 10 and reducing complexity of the tire 10.

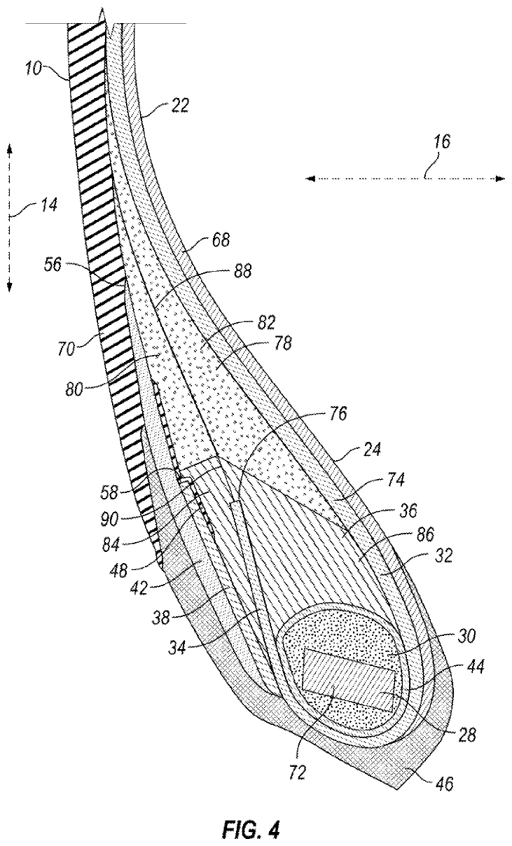

An alternate design of the bead 24 is illustrated in FIG. 4 which again shows the left hand bead 24 (the right side bead 24 being a mirror image) in cross-section. The products of the FIG. 4 design and their arrangement are the same as that previously discussed and a repeat of this information is not necessary. However, there are some differences in the configuration of the bead 24 and the differences from the FIG. 3 embodiment will be discussed. FIG. 4 includes a recycled bead filler 78 that is not split into a first zone 92 and a second zone 94 such that two zones are not present. The recycled bead filler 78 is free from engagement with the bead core 28, but the virgin bead filler 36 engages the bead core 28. The return casing ply 34 is located in the virgin bead filler 36 with the first layer 84 on one side in the axial direction 16 and the second layer 86 on the other side in the axial direction 16. The interface 90 engages the interface 88 and extends from it to the outward radial terminal end 76. The virgin bead filler 36 has two layers 84, 86 that engage the return casing ply 34, and both of these layers 84, 86 engage the outward radial terminal end 76. The first layer 84 engages the stiffener layer 38 and the tape 48.

There is no recycled bead filler 78 located between the stiffener layer 38 and the return casing ply 34, and the recycled bead filler 78 does not engage the outward radial terminal end 76, the return casing ply 34, the outward radial terminal end 58, or the stiffener layer 38. The virgin bead filler 36 is continuous in the radial direction 14, and the recycled bead filler 78 is likewise continuous in the radial direction 14. The majority of the recycled bead filler 78 is outward from the majority of the virgin bead filler 36 in the radial direction 14. However, due to the geometry of the interface between the bead fillers 36, 78, some portions of the recycled bead filler 78 are in fact closer to the central axis 12 in the radial direction 14 than are some portions of the virgin bead filler 36.

In the various embodiments of the tire 10, the volume of material making up the virgin bead filler 36 is the same as, greater than, or less than the volume of material making up the recycled bead filler 78. In this regard, the volume can be determined as a size comparison of the area of one bead filler 36 to the other bead filler 78 when taking a cross-section of the bead 24 such as the ones shown in FIGS. 2-5.

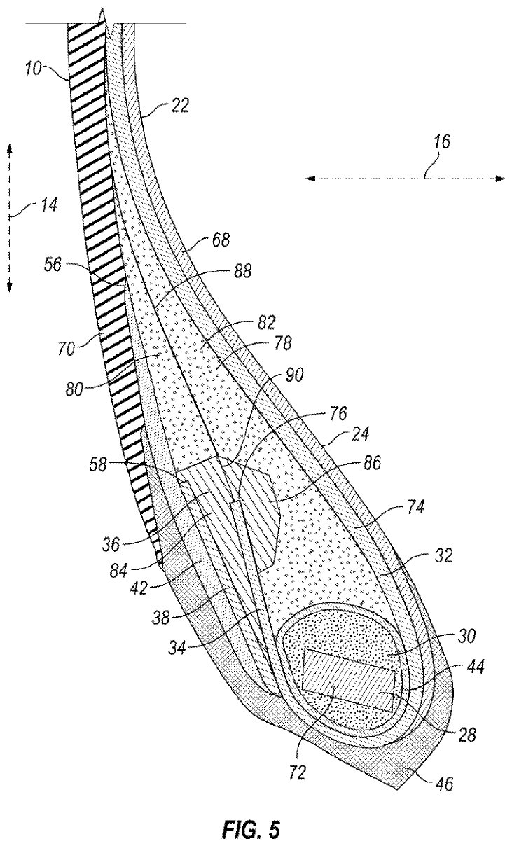

Another exemplary embodiment of the tire 10 is shown in FIG. 5 that includes products configured like those of FIG. 3 such that a repeat of this information is not necessary. The difference in FIG. 5 concerns the configuration of the recycled bead filler 78 and the virgin bead filler 36. Here, the recycled bead filler 78 engages the wrapping tissue 44 of the bead core 28 and extends from the bead core 28 to a portion at the outward location of the bead 24 in the radial direction 14. The recycled bead filler 78 is continuous from the bead 24 to the upward portion of the bead 24 in the radial direction 14. The recycled bead filler 78 extends in a continuous manner from the bead core 28 to a location outward in the radial direction 14 from the virgin bead filler 36 such that the recycled bead filler 78 extends to a location farther outward from the central axis 12 in the radial direction 14 than does the virgin bead filler 36.

The virgin bead filler 36 extends from the bead layer 42 towards the main portion 74 inward in the axial direction 16 but stops short of and does not engage the main portion 74. The virgin bead filler 36 is located between the return casing ply 34 and the stiffener layer 38 and engages both of these products such that no other product of the tire 10 is located between the return casing ply 34 and the stiffener layer 38 other than the virgin bead filler 36. The tape 48 is not present, but could be present in other embodiments. The entire outward radial terminal end 58 engages only the virgin bead filler 36 and no other product. The virgin bead filler first layer 84 engages the stiffener layer 38, but the virgin bead filler second layer 86 does not engage the stiffener layer 38. In a similar manner, the outward radial terminal end 76 engages only the virgin bead filler 36, and in particular the interface 90 such that both the virgin bead filler first layer 84 and the virgin bead filler second layer 86 both engage the outward radial terminal end 76.

Different configurations of the bead 24 with the virgin bead filler 36 and the recycled bead filler 78 are possible and it is to be understood that the configurations illustrated herein are only exemplary and that others are possible. Further, although the two fillers 36, 78 are both shown as being made of two layers 84/86 and 80/82, it is to be understood that the two fillers 36, 78 can compose any number of layers or no layers in accordance with different exemplary embodiments.

In the variously disclosed embodiments, it can be seen that the outward radial terminal end 58 and the outward radial terminal end 76 are not in engagement with the recycled bead filler 78 but are instead in contact with, or are closer to, the virgin bead filler 36. This arrangement protects the ends of the stiffener layer 38 and the return casing ply 34 to maintain the expected cured tire 10 endurance performance for crack initiation, formation and propagation. The ends of the stiffener layer 38 and the return casing ply 34 are thus protected from recycled rubber products to maintain tire 10 endurance performance for crack initiation, formation, and propagation. The ends of the stiffener layer 38 and the return casing ply 34 can be situated so that a majority of the stiffener layer 38 and return casing ply 34 extending from their ends 58, 76 are closer to the virgin bead filler 36 than to the recycled bead filler 78.

As disclosed in the various embodiments herein, the bead 24 includes fillers 36, 78 that have multiple layers 80, 82, 84, 86. These multiple layers 80, 82, 84, 86 can be layered into the bead 24 using a coextrusion process. Other combinations of layering could be created by mixing and matching the disclosed arrangements.

The various embodiments disclosed herein can incorporate any type of recycled rubber into the recycled bead filler 78 such that the bead 24 can incorporate any type of recycled rubber. The recycled rubber can be included only in the bead 24 of the tire 10, and need not be in other portions of the tire 10 such as the sidewall, tread 20, or undertread layers. In other embodiments, the recycled rubber may also be included in other portions of the tire 10 such as the sidewall, tread 20, or undertread layers in addition to the beads 24. The volume of the bead 24 can be from 1% to 10%, from 10%-30%, from 12%-15%, from 5%-15%, from 15%-25%, from 20%-30%, from 25%-35%, 12%, 15%, 20%, 10%, or from 12%-20%, or up to 15% of recycled rubber. In yet other embodiments, the volume of the bead 24 could be from 30%-50%, from 50%-70%, from 70%-90%, from 90%-100%, or 100% of recycled rubber. As such, recycled rubber could make up any portion of the volume of the bead 24 in other arrangements. The volume can be determined by taking a cross-section of the bead 24 and measuring the area of the recycled rubber in comparison to the total area of the cross-section of the bead 24. In some embodiments, new tires 10 for light duty vehicles can include 12% recycled rubber in the bead 24, and new tires 10 for commercial vehicles can include 15% recycled rubber in the bead 24. The incorporation of recycled rubber in the geometry introduced herein in the bead 24 may be done so without degrading tire 10 performance or increasing manufacturing cost. Existing bead 24 endurance and durability performance may be maintained with the incorporation of recycled rubber though the use of the multi-layer 80/82 and 84/86 strategy in some embodiments as discussed herein. The multi-layer arrangements and placement of the recycled bead filler 78 allow the bead 24 of the tire 10 to maintain product performance even though recycled materials are included therein.

The recycled bead filler 78 can be any type of recycled rubber, which is rubber product that has been cured and previously used in a product such as a tire or rubber hose. The rubber in the recycled bead filler 78 is always vulcanized rubber, and may be reprocessed vulcanized rubber from a tire that is put into the current tire 10. In some embodiments, the recycled rubber is micronized rubber powder (MRP) that is obtained from used tires. In some embodiments, the micronized rubber powder is a micronized rubber composition having a particle size which is within a range of 40 mesh to 200 mesh, wherein the micronized rubber composition is comprised of at least 10 weight percent solution styrene-butadiene rubber. The micronized rubber powder may be as that provided in U.S. Pat. No. 9,815,974 entitled “recycled micronized rubber formulation having improved abrasion resistance”, the contents of which are incorporated by reference herein for all purposes.

While the present subject matter has been described in detail with respect to specific embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be apparent.

1. A tire that has a central axis, a radial direction, and an axial direction, comprising:
a tread;
a casing that carries the tread, wherein the casing has a bead that has:
a bead core that has a rod and padding gum;
a reinforcement ply that wraps around a section of the bead core, wherein the reinforcement ply has a main portion, wherein the reinforcement ply has a return casing ply that extends from the main portion and is outboard in the axial direction from the bead core, wherein the return casing ply has an outward radial terminal end;
a virgin bead filler that has a portion radially outward from the bead core in the radial direction and axially outboard from the reinforcement ply in the axial direction, wherein the virgin bead filler includes virgin rubber;
a recycled bead filler that has a portion radially outward from the bead core in the radial direction and axially outboard from the outward radial terminal end of the return casing ply in the axial direction, wherein the recycled bead filler includes recycled rubber;
a stiffener layer that has a portion located outboard from the return casing ply in the axial direction, wherein the stiffener layer has an outward radial terminal end;
wherein the outward radial terminal end of the return casing ply is closer to the virgin bead filler than to the recycled bead filler, and wherein the outward radial terminal end of the return casing ply is not in engagement with the recycled bead filler;
wherein the outward radial terminal end of the stiffener layer is closer to the virgin bead filler than to the recycled bead filler, and wherein the outward radial terminal end of the stiffener layer is not in engagement with the recycled bead filler.

2. The tire as set forth in claim 1, further comprising tape that engages the outward radial terminal end of the stiffener layer, wherein the outward radial terminal end of the stiffener layer does not engage the virgin bead filler.

3. The tire as set forth in claim 1, wherein the outward radial terminal end of the stiffener layer engages the virgin bead filler, and wherein the outward radial terminal end of the return casing ply engages the virgin bead filler.

4. The tire as set forth in claim 1, wherein the bead core has wrapping tissue that engages the padding gum, wherein the wrapping tissue engages the reinforcement ply.

5. The tire as set forth in claim 1, wherein the bead has a bead layer that engages the stiffener layer and has a portion outboard in the axial direction from the stiffener layer,
wherein the bead has an anti-abrasive strip that has a portion located outboard in the axial direction from the bead layer, wherein the anti-abrasive strip has a portion located radially inward from the bead core, wherein a portion of the bead layer is located between the stiffener layer and the anti-abrasive strip in the axial direction.

6. The tire as set forth in claim 1, wherein the recycled bead filler is free from engagement with the bead core, wherein the recycled bead filler is free from engagement with the return casing ply, wherein the recycled bead filler is free from engagement with the stiffener layer, and wherein the virgin bead filler is located between the return casing play and the stiffener layer.

7. The tire as set forth in claim 1, wherein the recycled bead filler engages the bead core, wherein the recycled bead filler engages the return casing ply, wherein the recycled bead filler is continuous from the bead core to a location outward in the radial direction from the virgin bead filler such that the recycled bead filler extends to a location farther outward in the radial direction than does the virgin bead filler.

8. The tire as set forth in claim 7, wherein the virgin bead filler is located between the stiffener layer and the return casing ply, and wherein the virgin bead filler is not in engagement with the main portion of the reinforcement ply.

9. The tire as set forth in claim 1, wherein the recycled bead filler is discontinuous such that the recycled bead filler is located both radially inward and outward of the virgin bead filler, wherein the virgin bead filler extends in the axial direction from the main portion of the reinforcement ply to a location outboard in the axial direction from the outward radial terminal end of the return casing ply;
wherein the recycled bead filler engages the bead core;
wherein a portion of the recycled bead filler is located between the return casing ply and the stiffener layer;
wherein a portion of the virgin bead filler is located between the return casing ply and the stiffener layer.

10. The tire as set forth in claim 1, wherein the recycled bead filler has a recycled bead filler first layer and a recycled bead filler second layer,
wherein the virgin bead filler has a virgin bead filler first layer and a virgin bead filler second layer.

11. The tire as set forth in claim 10, wherein an interface between the recycled bead filler first layer and the recycled bead filler second layer engages an interface between the virgin bead filler first layer and the virgin bead filler second layer.

12. The tire as set forth in claim 10, wherein the interface between the virgin bead filler first layer and the virgin bead filler second layer engages the outward radial terminal end of the return casing ply.

13. The tire as set forth in claim 1, wherein from 10%-30% of the volume of the bead is made of micronized rubber powder that is present in the recycled bead filler.

14. The tire as set forth in claim 13, wherein from 12%-15% of the volume of the bead is made of micronized rubber powder that is present in the recycled bead filler.

15. The tire as set forth in claim 1, wherein the recycled bead filler includes a micronized rubber composition having a particle size which is within a range of 40 mesh to 200 mesh, wherein the micronized rubber composition is comprised of at least 10 weight percent solution styrene-butadiene rubber.

16. The tire as set forth in claim 1, wherein the tire is a heavy duty truck tire.
